(19) United States
(12) Patent Application Publication
(10) Pub. No.: US 2024/0058962 A1
(43) Pub. Date: Feb. 22, 2024

(54) SYSTEMS AND METHODS OF COORDINATING A MOBILE ROBOT AND PARCEL HANDLING EQUIPMENT

(71) Applicant: Boston Dynamics, Inc., Waltham, MA (US)

(72) Inventors: Michael Murphy, Carlisle, MA (US); Alexander Perkins, Lincoln, MA (US); Guillermo Diaz-Lankenau, Santa Clara, CA (US); Matthew Turpin, Newton, MA (US); Phillip Cable, Waltham, MA (US)

(73) Assignee: Boston Dynamics, Inc., Waltham, MA (US)

(21) Appl. No.: 18/446,786

(22) Filed: Aug. 9, 2023

Related U.S. Application Data
(60) Provisional application No. 63/398,909, filed on Aug. 18, 2022.

(51) Int. Cl. B25J 9/16

(52) U.S. Cl. CPC B25J 9/1666

(57) ABSTRACT

A kit includes a computing device configured to control motion of equipment for receiving one or more parcels in an environment of a mobile robot. The kit also includes a structure configured to couple to the equipment. The structure comprises an identifier configured to be sensed by a sensor of the mobile robot.

### RELATED APPLICATIONS

This application claims the benefit under 35 U.S.C. § 119(e) of U.S. Provisional Patent Application Ser. No. 63/398,909, filed Aug. 18, 2022, and entitled “SYSTEMS AND METHODS OF COORDINATING A MOBILE ROBOT AND PARCEL HANDLING EQUIPMENT,” the entire contents of which is incorporated herein by reference.

### TECHNICAL FIELD

This application relates generally to robotics and more specifically to systems, methods and apparatuses, including computer programs, for determining motions and/or operating parameters for parcel handling equipment and/or robotic devices.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Parcel handling equipment (e.g., one or more conveyors) is regularly used in warehouse operations, such as in truck unloading and/or loading processes. To streamline warehouse operations, mobile robots can autonomously or semi-autonomously coordinate their movements with existing parcel handling equipment and/or other existing warehouse infrastructure. For example, parcel handling equipment can be controlled to stay at a specified distance from a parcel-moving robot (or within a specified range of distances) during operation. Under this scheme, the parcel handling equipment can remain close enough to the robot to allow the robot to move multiple parcels successively without traveling excessively, but far enough away to avoid unwanted collisions (e.g., collisions between the robot and entities such as the parcel handling equipment, humans in the environment, and/or other entities of concern).

In some circumstances, this setup can reduce or eliminate the need for physical guarding systems (e.g., between people and mobile robots) in warehouse environments. Additionally, one or more aspects of the technology described herein may enable certain warehouse spaces (e.g., high-activity areas such as loading docks) to be used by mobile robots and workers simultaneously. Coordinated control between mobile robots and parcel handling equipment can enable mobile robots to move at productive but safe speeds throughout the warehouse without the need for interrupting other warehouse operations or deploying and moving bulky or expensive equipment, making operations smoother and more efficient.

In one aspect, the invention features a kit. The kit includes a computing system configured to control motion of parcel handling equipment in an environment of a mobile robot. The kit also includes a structure configured to couple to the parcel handling equipment. The structure comprises an identifier configured to be sensed by a sensor of the mobile robot.

In some embodiments, the parcel handling equipment comprises a conveyor. In some embodiments, the conveyor is a telescopic conveyor, a gravity conveyor, and/or an accordion conveyor. In some embodiments, the identifier comprises a fiducial, a quick response (QR) code, and/or a bar code. In some embodiments, the identifier is encoded with information about a safety zone of the robot (e.g., a configuration of the zone and/or one or more parameters, such as ramp size). In some embodiments, the identifier is arranged on a flexible material and/or a fabric. In some embodiments, the identifier comprises a RFID tag. In some embodiments, the identifier comprises a target configured to receive and/or reflect a LiDAR signal (e.g., from the robot and/or a coupled device).

In some embodiments, the structure comprises a compliant member configured to adjust to variations in a clearance of the parcel handling equipment relative to a ground plane. In some embodiments, the structure includes a physical barrier configure to constrain a position of the robot relative to the parcel handling equipment. In some embodiments, the computing system is configured to issue control instructions to constrain the robot relative to the parcel handling equipment. In some embodiments, physical barrier comprises a push bar. In some embodiments, the physical barrier comprises one or more wings extending laterally from the structure. In some embodiments, the physical barrier comprises one or more pivot points.

In some embodiments, a motion of the robot is influenced by a safety zone control system in communication with the computing system (e.g., based on operating parameters such as speed limits or maximum stop times). In some embodiments, the computing system is configured to communicate with a motion control system of the parcel handling equipment. In some embodiments, the computing system is configured to control motion of the parcel handling equipment by controlling one or more motors of the parcel handling equipment. In some embodiments, the computing system is configured to control motion of the parcel handling equipment based at least in part on position data sensed by the robot. In some embodiments, the position data reflects a position of the parcel handling equipment relative to the robot. In some embodiments, the position data reflects a position of the parcel handling equipment in the environment. In some embodiments, the position data reflects a pose of the parcel handling equipment.

In some embodiments, the kit includes a wireless communication system in communication with the robot and the computing system. In some embodiments, the wireless communication system is configured with a black channel for transmitting safety data. In some embodiments, the kit includes a switch in communication with the computing system. In some embodiments, the switch is configured to toggle the computing system between an automated mode and a manual mode.

In some embodiments, the sensor includes an ultrasonic sensor, a RF sensor, a laser and/or a camera. In some embodiments, the kit includes an encoder configured to communicate with the computing system and/or measure a length of the parcel handling equipment. In some embodiments, the length of the parcel handling equipment comprises a length measured between the encoder and an end of the parcel handling equipment. In some embodiments, the length of the parcel handling equipment comprises a length measured between the encoder and an end of a section of the parcel handling equipment.

In some embodiments, the robot includes a robotic manipulator. In some embodiments, the robot includes a robotic arm. In some embodiments, the computing system is configured to maintain a gap between the parcel handling equipment and the robot. In some embodiments, the gap is between 0.5 meters and 1.5 meters. In some embodiments, the gap is maintained based on updated distance measurements between the robot and the parcel handling equipment. In some embodiments, the updated distance measurements are received at a specified frequency. In some embodiments, the gap is maintained based on updated distance measurements between the robot and the parcel handling equipment. In some embodiments, the updated distance measurements are received after the robot moves.

In another aspect, the invention features a method. The method includes receiving, by a computing system configured to control parcel handling equipment in an environment of a robot, a request to move the parcel handling equipment according to one or more specifications. The method includes controlling, by the computing system, the parcel handling equipment to move in accordance with the one or more specifications. The request to move the parcel handling equipment is based on information about a position of the parcel handling equipment.

In some embodiments, the position of the parcel handling equipment comprises a distance to a robot in the environment of the robot. In some embodiments, the position of the parcel handling equipment comprises a position within the environment. In some embodiments, the position of the parcel handling equipment includes a pose of the parcel handling equipment. In some embodiments, the one or more specifications include at least one of a target distance to the robot, a minimum permitted distance to the robot, or a maximum permitted distance to the robot. In some embodiments, the one or more specifications include at least one of a target ground speed of the parcel handling equipment, a minimum ground speed of the parcel handling equipment, or a maximum ground speed of the parcel handling equipment. In some embodiments, the one or more specifications include at least one of a target move time of the parcel handling equipment, a minimum move time of the parcel handling equipment, or a maximum move time of the parcel handling equipment. In some embodiments, the one or more specifications include at least one of a target extension length of the parcel handling equipment, a minimum extension length of the parcel handling equipment, or a maximum extension length of the parcel handling equipment. In some embodiments, the one or more specifications include at least one of a target belt speed of the parcel handling equipment, a minimum belt speed of the parcel handling equipment, or a maximum belt speed of the parcel handling equipment. In some embodiments, the one or more specifications include a target pitch axis of the parcel handling equipment.

In some embodiments, the information includes an indication of a presence or absence of an entity in a specified safety zone in the environment of the robot. In some embodiments, the method includes receiving, by a sensor in communication with the computing device, information reflecting a distance to an end of the parcel handling equipment (e.g., a point on the parcel handling equipment, a point fixed relative to the parcel handling equipment, and/or an end of a section of the parcel handling equipment). In some embodiments, controlling the parcel handling equipment to move includes physically blocking the mobile robot from moving into one or more regions of the environment. In some embodiments, controlling the parcel handling equipment to move includes preventing the mobile robot from moving based on one or more control constraints, the one or more control constraints based on data sensed by the mobile robot.

In some embodiments, the computing system is configured to switch between an automatic control mode and a manual control mode. In some embodiments, controlling the parcel handling equipment to move includes generating a control instruction that accounts for one or more motion characteristics of the parcel handling equipment. In some embodiments, the one or more motion characteristics of the parcel handling equipment include a command latency period, a maximum ground speed of the parcel handling equipment, and/or a maximum belt speed of the parcel handling equipment. In some embodiments, controlling the parcel handling equipment to move includes controlling motion of a belt of the parcel handling equipment. In some embodiments, controlling the parcel handling equipment to move includes controlling an extension length and/or a pitch of the parcel handling equipment. In some embodiments, controlling the parcel handling equipment to move includes controlling a lateral movement of the parcel handling equipment.

In another aspect, the invention features a method. The method includes receiving, by a computing system of a robot, information indicating a position of parcel handling equipment in an environment of the robot. The method includes requesting, by the computing system, that the parcel handling equipment move in accordance with one or more specifications. The method includes receiving, by the computing system, from a sensor in communication with the computing system, information indicating whether the parcel handling equipment has moved in accordance with the one or more specifications.

In some embodiments, the information indicating a position of the parcel handling equipment includes a pose of the parcel handling equipment. In some embodiments, the computing system is configured to control the parcel handling equipment to follow the robot. In some embodiments, receiving the information indicating the position of the parcel handling equipment in the environment of the robot occurs periodically. In some embodiments, the information indicating the position of the parcel handling equipment in the environment of the robot is provided on a structure configured to couple to the parcel handling equipment.

In some embodiments, the information indicating the position of the parcel handling equipment comprises a distance from the parcel handling equipment to the mobile robot. In some embodiments, the information indicating the position of the parcel handling equipment comprises a position within the environment. In some embodiments, the one or more specifications include at least one of a target distance to the mobile robot, a minimum permitted distance to the mobile robot, or a maximum permitted distance to the mobile robot. In some embodiments, the one or more specifications include at least one of a target ground speed of the parcel handling equipment, a minimum ground speed of the parcel handling equipment, or a maximum ground speed of the parcel handling equipment. In some embodiments, the one or more specifications include at least one of a target move time of the parcel handling equipment, a minimum move time of the parcel handling equipment, or a maximum move time of the parcel handling equipment. In some embodiments, the one or more specifications include at least one of a target extension length of the parcel handling equipment, a minimum extension length of the parcel handling equipment, or a maximum extension length of the parcel handling equipment. In some embodiments, the one or more specifications include at least one of a target belt speed of the parcel handling equipment, a minimum belt speed of the parcel handling equipment, or a maximum belt speed of the parcel handling equipment. In some embodiments, the one or more specifications include a target pitch axis of the parcel handling equipment. In some embodiments, the information indicating a position of the parcel handling equipment includes an indication of a presence or absence of an entity in a specified safety zone in the environment of the mobile robot. In some embodiments, the method further comprises receiving, by a sensor in communication with the computing system, information indicating a distance to an end of the parcel handling equipment.

In another aspect, the invention features a method. The method includes sensing, by a mobile robot, a structure coupled to parcel handling equipment in an environment of the mobile robot. The sensing provides information reflecting a position of the parcel handling equipment. The method includes requesting, by the mobile robot, the parcel handling equipment to move according to one or more specifications generated based on the information. The method includes controlling, by a computing device of the parcel handling equipment, the parcel handling equipment to move according to the one or more specifications. The method includes sensing, by the mobile robot, the structure to determine whether the parcel handling equipment has moved in accordance with the one or more specifications.

In some embodiments, the parcel handling equipment is configured to service multiple bays and/or to move laterally between bays. In some embodiments, the information indicating a position of the parcel handling equipment comprises a distance from the parcel handling equipment to the mobile robot. In some embodiments, the information indicating a position of the parcel handling equipment comprises a position within the environment. In some embodiments, the information indicating a position of the parcel handling equipment includes a pose of the parcel handling equipment.

In some embodiments, the one or more specifications include at least one of a target distance to the mobile robot, a minimum permitted distance to the mobile robot, or a maximum permitted distance to the mobile robot. In some embodiments, the one or more specifications include at least one of a target ground speed of the parcel handling equipment, a minimum ground speed of the parcel handling equipment, or a maximum ground speed of the parcel handling equipment. In some embodiments, the one or more specifications include at least one of a target move time of the parcel handling equipment, a minimum move time of the parcel handling equipment, or a maximum move time of the parcel handling equipment. In some embodiments, the one or more specifications include at least one of a target extension length of the parcel handling equipment, a minimum extension length of the parcel handling equipment, or a maximum extension length of the parcel handling equipment. In some embodiments, the one or more specifications include at least one of a target belt speed of the parcel handling equipment, a minimum belt speed of the parcel handling equipment, or a maximum belt speed of the parcel handling equipment. In some embodiments, the one or more specifications include a target pitch axis of the parcel handling equipment. In some embodiments, the information indicating a position of the parcel handling equipment includes an indication of a presence or absence of an entity in a specified safety zone in the environment of the mobile robot.

In some embodiments, the method further comprises receiving, by a sensor, information indicating a distance to an end of the parcel handling equipment. In some embodiments, controlling the parcel handling equipment to move according to the one or more specifications includes physically blocking the mobile robot from moving into one or more regions of the environment. In some embodiments, controlling the parcel handling equipment to move according to the one or more specifications includes preventing the mobile robot from moving based on one or more control constraints, the one or more control constraints based on data sensed by the mobile robot. In some embodiments, a computing system in communication with the parcel handling equipment is configured to switch between an automatic control mode and a manual control mode. In some embodiments, controlling the parcel handling equipment to move according to the one or more specifications includes generating a control instruction that accounts for one or more motion characteristics of the parcel handling equipment. In some embodiments, the one or more motion characteristics of the parcel handling equipment include a command latency period, a maximum ground speed of the parcel handling equipment, or a maximum belt speed of the parcel handling equipment. In some embodiments, controlling the parcel handling equipment to move according to the one or more specifications includes controlling motion of a belt of the parcel handling equipment. In some embodiments, controlling the parcel handling equipment to move according to the one or more specifications includes controlling an extension length and/or a pitch of the parcel handling equipment. In some embodiments, controlling the parcel handling equipment to move according to the one or more specifications includes controlling a lateral movement of the parcel handling equipment.

In another aspect, the invention features a computing system of a kit for parcel handling equipment. The computing system includes data processing hardware and memory hardware in communication with the data processing hardware. The memory hardware stores instructions that when executed on the data processing hardware cause the data processing hardware to perform operations. The operations comprise receiving from a mobile robot, an instruction to control motion of parcel handling equipment according to one or more specifications generated based on a position of the parcel handling equipment, and controlling motion of the parcel handling equipment according to the one or more specifications.

In some embodiments, the parcel handling equipment comprises a conveyor. In some embodiments, the conveyor is a telescopic conveyor, a gravity conveyor, or an accordion conveyor. In some embodiments, controlling motion of the parcel handling equipment according to the one or more specifications comprises constraining the mobile robot relative to the parcel handling equipment. In some embodiments, a motion of the mobile robot is influenced by a safety zone control system in communication with the computing system. In some embodiments, the operations further comprise communicating with a motion control system of the parcel handling equipment. In some embodiments, controlling motion of the parcel handling equipment comprises controlling one or more motors of the parcel handling equipment.

In some embodiments, controlling motion of the parcel handling equipment is based at least in part on position data sensed by the mobile robot. In some embodiments, the position data reflects a position of the parcel handling equipment relative to the mobile robot. In some embodiments, the position data reflects a position of the parcel handling equipment in the environment. In some embodiments, the position data reflects a pose of the parcel handling equipment. In some embodiments, the operations further comprise receiving, from an encoder a length of the parcel handling equipment, and controlling motion of the parcel handling equipment based, at least in part, on the length of the parcel handling equipment. In some embodiments, the length of the parcel handling equipment comprises a length measured between the encoder and an end of the parcel handling equipment. In some embodiments, the length of the parcel handling equipment comprises a length measured between the encoder and an end of a section of the parcel handling equipment.

In some embodiments, the mobile robot includes a robotic manipulator. In some embodiments, the mobile robot includes a robotic arm. In some embodiments, controlling the parcel handling equipment comprises maintaining a gap between the parcel handling equipment and the mobile robot. In some embodiments, the gap is between 0.5 meters and 1.5 meters. In some embodiments, the gap is maintained based on updated distance measurements between the mobile robot and the parcel handling equipment, the updated distance measurements received at a specified frequency. In some embodiments, the gap is maintained based on updated distance measurements between the mobile robot and the parcel handling equipment, the updated distance measurements received after the mobile robot moves.

In another aspect, the invention features a computing system of a mobile robot. The computing system includes data processing hardware and memory hardware in communication with the data processing hardware. The memory hardware stores instructions that when executed on the data processing hardware cause the data processing hardware to perform operations. The operations comprise receiving information indicating a position of parcel handling equipment in an environment of the mobile robot, requesting that the parcel handling equipment move in accordance with one or more specifications, and receiving from a sensor in communication with the computing system, information indicating whether the parcel handling equipment has moved in accordance with the one or more specifications.

In some embodiments, the information indicating a position of the parcel handling equipment includes a pose of the parcel handling equipment. In some embodiments, the computing system is configured to control the parcel handling equipment to follow the mobile robot. In some embodiments, receiving the information indicating the position of the parcel handling equipment in the environment of the mobile robot occurs periodically. In some embodiments, the information indicating the position of the parcel handling equipment in the environment of the mobile robot is provided on a structure configured to couple to the parcel handling equipment, the structure comprising an identifier configured to be sensed by a sensor of the mobile robot. In some embodiments, the information indicating the position of the parcel handling equipment comprises a distance from the parcel handling equipment to the mobile robot. In some embodiments, the information indicating the position of the parcel handling equipment comprises a position within the environment.

In some embodiments, the one or more specifications include at least one of a target distance to the mobile robot, a minimum permitted distance to the mobile robot, or a maximum permitted distance to the mobile robot. In some embodiments, the one or more specifications include at least one of a target ground speed of the parcel handling equipment, a minimum ground speed of the parcel handling equipment, or a maximum ground speed of the parcel handling equipment. In some embodiments, the one or more specifications include at least one of a target move time of the parcel handling equipment, a minimum move time of the parcel handling equipment, or a maximum move time of the parcel handling equipment. In some embodiments, the one or more specifications include at least one of a target extension length of the parcel handling equipment, a minimum extension length of the parcel handling equipment, or a maximum extension length of the parcel handling equipment. In some embodiments, the one or more specifications include at least one of a target belt speed of the parcel handling equipment, a minimum belt speed of the parcel handling equipment, or a maximum belt speed of the parcel handling equipment. In some embodiments, the one or more specifications include a target pitch axis of the parcel handling equipment. In some embodiments, the information indicating a position of the parcel handling equipment includes an indication of a presence or absence of an entity in a specified safety zone in the environment of the mobile robot.

In another aspect, the invention features a method (e.g., of retrofitting an existing conveyor with a new kit). The method includes coupling a computing system to parcel handling equipment in an environment of a robot. The computing system is configured to control motion of the parcel handling equipment. The method includes coupling a structure to the parcel handling equipment. The structure comprises an identifier configured to be sensed by a sensor of the robot. The method includes controlling the parcel handling equipment to move, based on sensed information reflecting a position of the parcel handling equipment, according to one or more specifications.

In some embodiments, the method includes sensing information reflecting whether the parcel handling equipment has moved in accordance with the one or more specifications. In some embodiments, the method further comprises coupling a computing system to the parcel handling equipment, the computing system configured to control motion of the parcel handling equipment. In some embodiments, the parcel handling equipment comprises a conveyor. In some embodiments, the conveyor is a telescopic conveyor, a gravity conveyor, or an accordion conveyor. In some embodiments, the identifier comprises a fiducial. In some embodiments, the identifier comprises a quick response code or bar code. In some embodiments, the identifier is encoded with information about a safety zone of the mobile robot. In some embodiments, the identifier is arranged on a flexible material. In some embodiments, the identifier is arranged on a fabric. In some embodiments, the identifier comprises a RFID tag. In some embodiments, the identifier comprises a target configured to receive and/or reflect a LiDAR signal. In some embodiments, the structure comprises a compliant member configured to adjust to variations in a clearance of the parcel handling equipment relative to a ground plane.

In some embodiments, the structure includes a physical barrier configured to constrain a position of the mobile robot relative to the parcel handling equipment. In some embodiments, the physical barrier comprises a push bar. In some embodiments, the physical barrier comprises one or more wings extending laterally from the structure. In some embodiments, the physical barrier comprises one or more pivot points. In some embodiments, a motion of the mobile robot is influenced by a safety zone control system. In some embodiments, the sensor is an ultrasonic sensor, a RF sensor, a laser or a camera. In some embodiments, the mobile robot includes a robotic manipulator. In some embodiments, the mobile robot includes a robotic arm.

In some embodiments, one or more components of the invention can improve safety and/or accuracy of detection of parcel handling equipment by mobile robots. In some embodiments, one or more components of the invention can be retrofitted to existing parcel handling equipment. In some embodiments, the invention can switch between operational modes (e.g., manual and automatic modes). In some embodiments, control of the parcel handling equipment can be accomplished through communication with an existing computing device (e.g., a PLC on a conveyor) and/or through wiring in new logic components to control the inputs and/or read the outputs of existing systems (e.g., manual control hardware such as motion control buttons).

In some embodiments, the parcel handling equipment integrates sensors that detect the mobile robot directly. In some embodiments, the mobile robot detects one or more parameters of the parcel handling equipment (e.g., a pose, extension length, position, zone identifier, etc.). In some embodiments, components on the front of the parcel handling equipment (e.g., visual fiducials and/or specific geometry) assist in the accuracy of this measurement. In some embodiments, one or more visual fiducials are mounted on a front side of the parcel handling equipment.

In some embodiments, the invention enables safe association of a mobile robot with a work zone. For example, multi-factor authentication can be used to provide a redundant input that allows the robot to associate to a work zone, connect to the parcel handling equipment, and/or establish a trusted connection with the zone's safety system. In some embodiments, visual fiducials and/or RF tags can be used to provide this information in machine readable form at the front of the parcel handling equipment (e.g., for safe association at start and/or re-start).

In some embodiments, the invention functions as part of the robot's safety system. In some embodiments, a physical bumper on the front of the parcel handling equipment (which can be used as a structure onto which the fiducials and/or RF tags are mounted) prevents a mobile robot from passing to the side of the parcel handling equipment, limiting the robot's operating space to the area in front of the parcel handling equipment only. In some embodiment, an encoder is added to the parcel handling equipment. In some embodiments, the encoder provides a minimum distance into the truck that the mobile robot must occupy at certain (e.g., all) times during operation. In some embodiments, blocking the robot from moving closer than the minimum distance can be accomplished through physical contact (e.g., by limiting the available space to fit by) and/or through sensors that trigger automatic stopping. In some embodiments, a bumper sensor that already exists on some kinds of parcel handling equipment is utilized, and extending the triggering area of this bumper is achieved by adding hardware (e.g., linkages and/or extensions).

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4 is a schematic view of a computing device in communication with a robot, together with a structure configured to attach to parcel handling equipment, according to an illustrative embodiment of the invention.

FIG. 5 is an illustration of a robot and parcel handling equipment separated by a gap during operation, according to an illustrative embodiment of the invention.

FIG. 6 is an illustration of a robot and parcel handling equipment having an attached structure, according to an illustrative embodiment of the invention.

FIGS. 7A-7B are illustrations of exemplary configurations of a sensor configured to sense an extension length of a conveyor, according to illustrative embodiments of the invention.

FIGS. 8A-8D are illustrations of exemplary elements of structures configured to couple to a conveyor, according to illustrative embodiments of the invention.

FIG. 9A is a front view photograph of an exemplary structure attached to a conveyor, according to an illustrative embodiment of the invention.

FIG. 9B is a perspective view illustration of a structure attached to a conveyor, according to an illustrative embodiment of the invention.

FIGS. 10A-10D are flow diagrams of methods according to illustrative embodiments of the invention.

FIG. 11 illustrates an example configuration of a robotic device, according to an illustrative embodiment of the invention.

### DETAILED DESCRIPTION

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

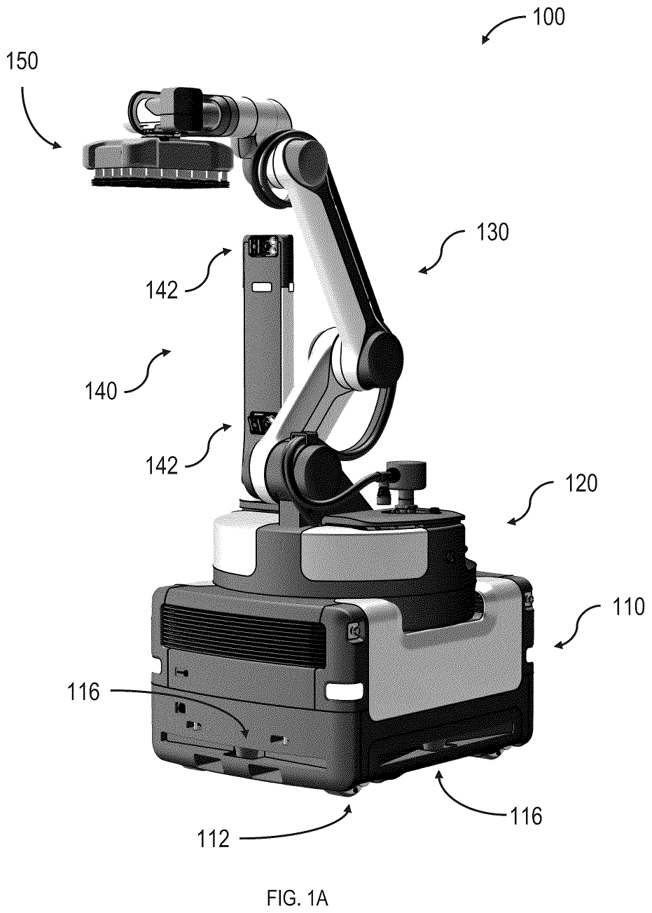

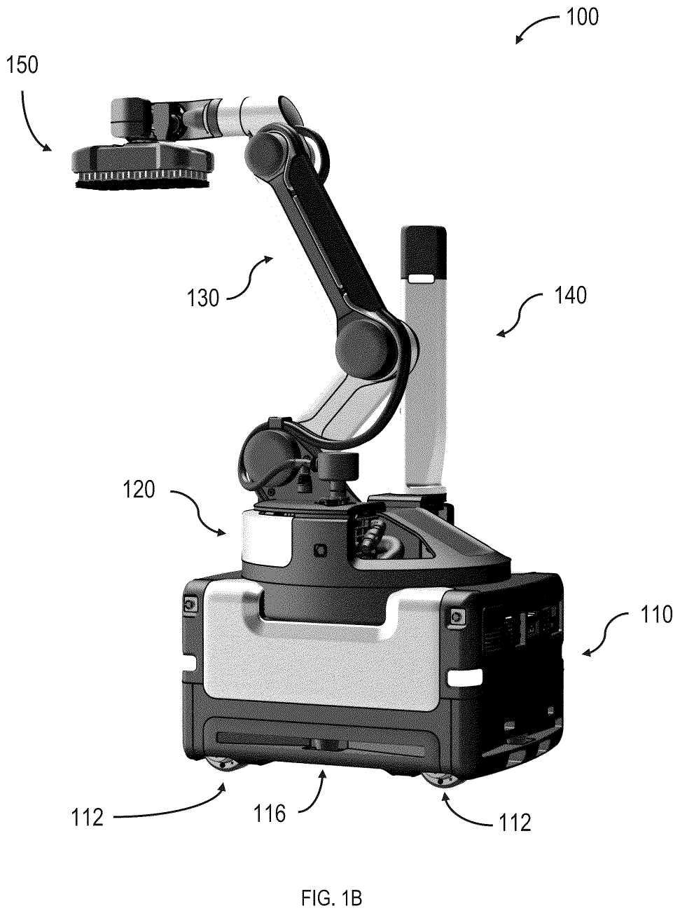

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

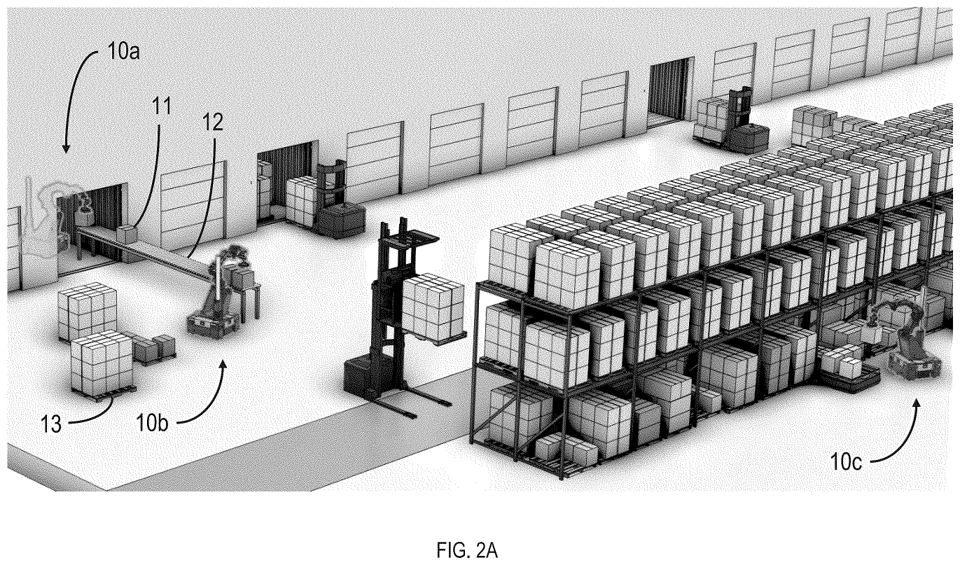

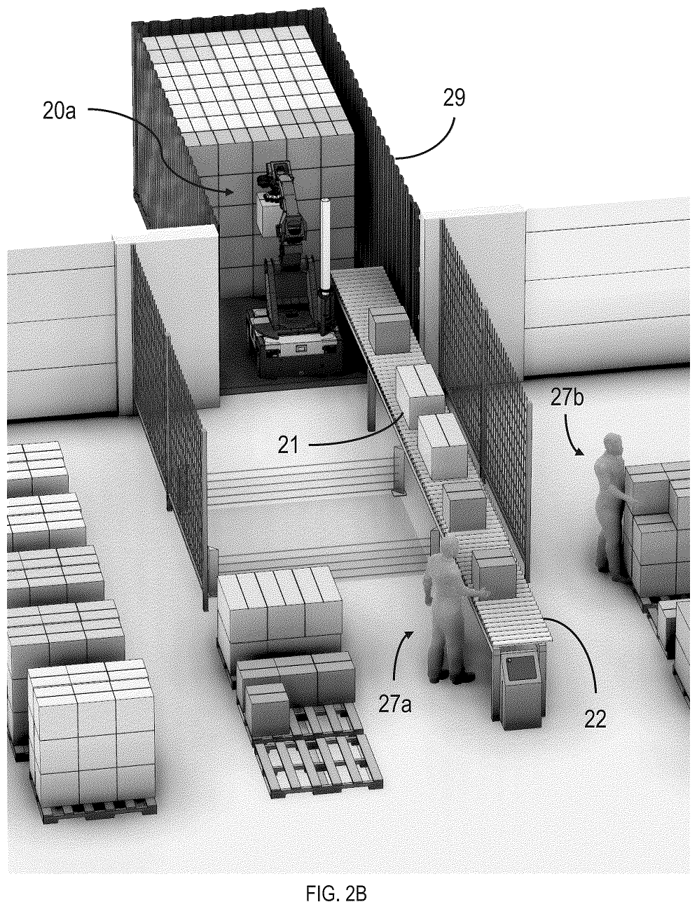

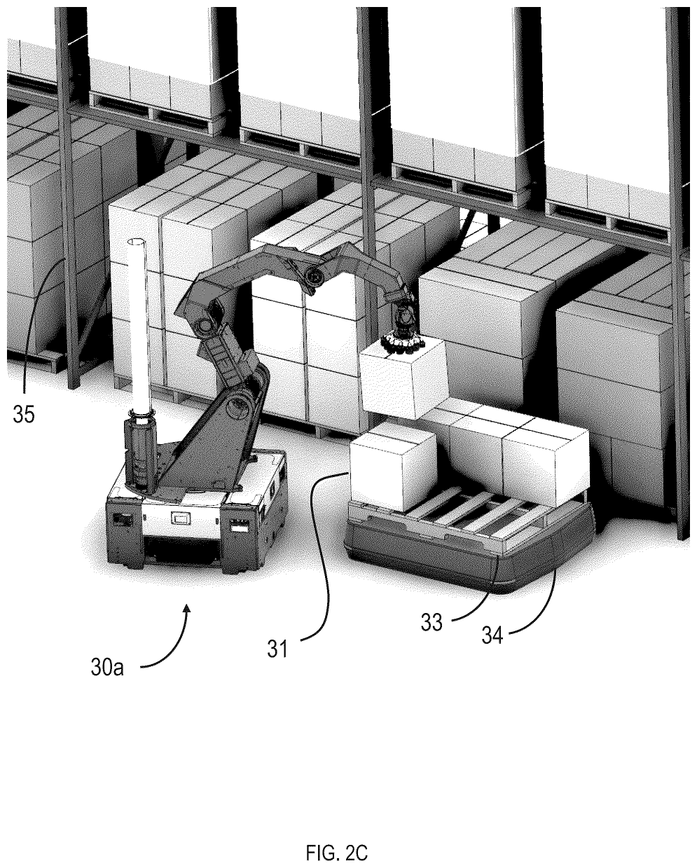

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

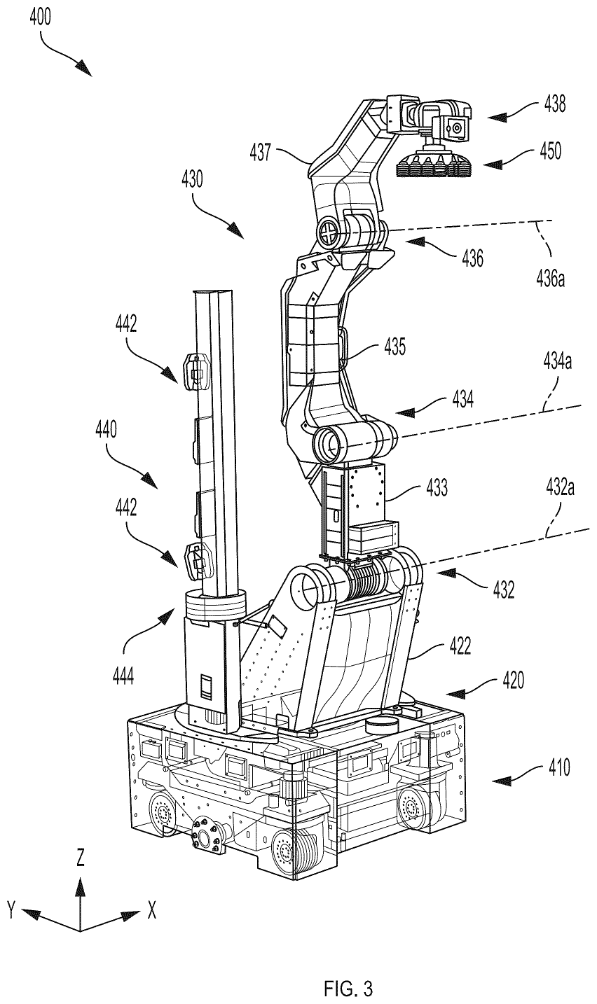

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

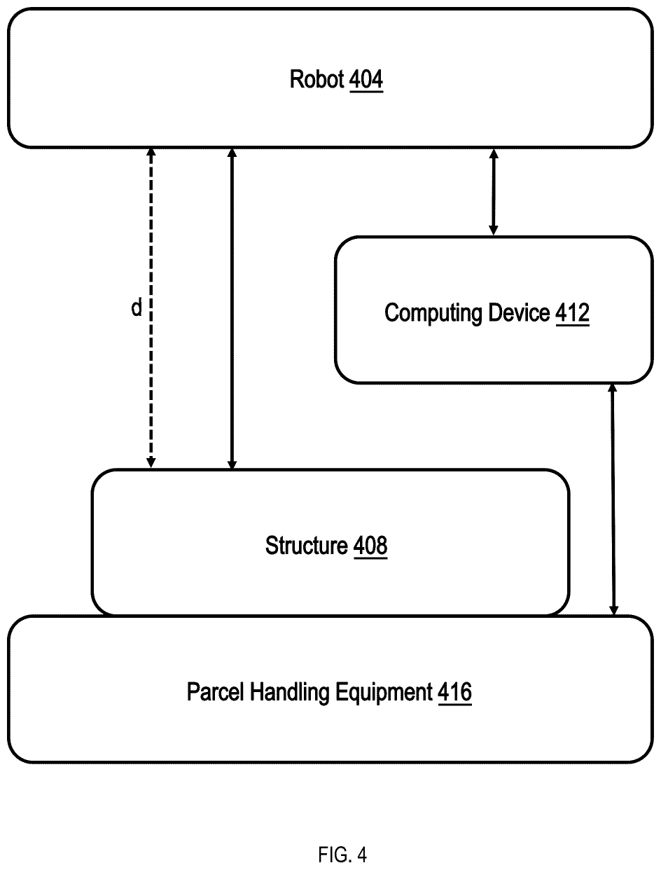

FIG. 4 is a schematic view of a computing device 412 in communication with a robot 404 (e.g., the robot 100 shown above in FIG. 1A or the robot 400 shown above in FIG. 3), together with a structure 408 configured to attach to parcel handling equipment 416 (e.g., a conveyor), according to an illustrative embodiment of the invention. The robot 404 is separated from the structure 408 (and/or the parcel handling equipment 416) by a gap (e.g., having distance d, as shown, or a range of permitted distances). In some embodiments, the computing device 412 is also in communication with the parcel handling equipment 416. In FIG. 4, the computing device 412 is shown as a separate component from the robot 404, but in some embodiments the computing device 412 can be included in, on, or as a part of the robot 404 or the parcel handling equipment 416. Also in FIG. 4, the structure 408 is shown as a separate component from the parcel handling equipment 416, but in some embodiments the structure 408 can be included in, on, or as part of the parcel handling equipment 416.

During operation, the computing device 412 controls (and/or influences) motion of the parcel handling equipment 416, e.g., to maintain a gap of substantially constant distance d (e.g., 0.9 m) between the robot 404 and the structure 408. In some embodiments, the computing device 412 controls the parcel handling equipment 416 to follow the robot 404 to maintain a gap within a certain target range of distances (e.g., 0.5 m-1.5 m). The computing device 412 receives information (e.g., periodically and/or each time a base of the robot 404 travels) reflecting a position and/or location of the structure 408. This information can be based on data sensed by a sensor of the robot 404, although in some embodiments the sensor can be separate from the robot 404.

The computing device 412 requests that the parcel handling equipment 416 move in accordance with one or more specifications (e.g., a target ground speed of the parcel handling equipment 416 and/or a target move time of the parcel handling equipment 416). The one or more specifications can be based, at least in part, on the distance d. The parcel handling equipment 416 can be controlled to move in accordance with the one or more specifications (e.g., by the computing device 412 and/or another computing device in communication with the parcel handling equipment 416, such as a motion controller or a zone controller). The computing device 412 can receive (e.g., from a sensor in communication with the computing device 412) information reflecting whether the parcel handling equipment 416 has moved in accordance with the one or more specifications. The one or more specifications can be communicated to (and/or enforced on) the parcel handling equipment 416 using reliable methods.

In some embodiments, the position of the parcel handling equipment 416 is specified by one or more of a distance from the robot 404, an absolute position within the environment (e.g., coordinates on a map), or a pose of the parcel handling equipment 416. In some embodiments, the one or more specifications include at least one of the following: a target distance to the robot, a minimum permitted distance to the robot, a maximum permitted distance to the robot, a target ground speed of the parcel handling equipment, a minimum ground speed of the parcel handling equipment, a maximum ground speed of the parcel handling equipment, a target move time of the parcel handling equipment, a minimum move time of the parcel handling equipment, a maximum move time of the parcel handling equipment, a target extension length of the parcel handling equipment, a minimum extension length of the parcel handling equipment, or a maximum extension length of the parcel handling equipment. In some embodiments, controlling the parcel handling equipment 416 to move includes controlling motion of a belt, an extension length, a pitch, forward/backward movement, and/or lateral movement (e.g., movement between bays) of the parcel handling equipment 416. In some embodiments, controlling the parcel handling equipment 416 to move includes accounting for one or more motion characteristics of the parcel handling equipment 416 (e.g., a command latency period, a maximum ground speed, and/or a maximum belt speed).

In some embodiments, the structure 408 and the computing device 412 are included in a kit that is configured to interact directly with the robot 404. In some embodiments, the robot 404 can interact directly with the parcel handling equipment 416. In some embodiments, the kit can be configured with one or more parameters of the parcel handling equipment 416 and/or report the parameter(s) to the robot 404. In some embodiments, the kit can measure one or more parameters of the parcel handling equipment 416, e.g., a maximum extension velocity, a maximum retraction velocity, a command latency, a stopping time, and/or a stopping distance. In some embodiments, measuring one or more parameters of the parcel handling equipment 416 enhances the ability of the kit to be used in connection with a wider variety of parcel handling equipment 416.

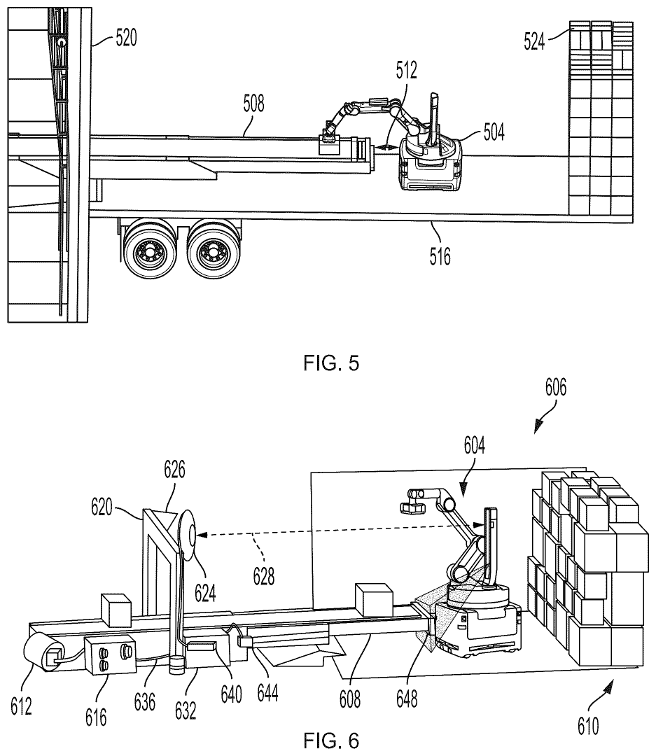

FIG. 5 is an illustration of a robot 504 and parcel handling equipment (here, a telescopic conveyor) 508 separated by a gap 512 during operation, according to an illustrative embodiment of the invention. The robot 504 is located on a truck 516 that is partially occupying a bay 520 and is partially outside the bay 520. The robot 504 is moving boxes from a stack of boxes 524 on the truck 516 to the conveyor 508. As the robot 504 removes boxes from the stack of boxes 524, it eventually needs to move closer to the stack of boxes 524 to remain located close enough to the next set of boxes in the stack that it aims to move. This motion of the robot toward the stack of boxes 524 will increase the size of the gap 512 if the conveyor 508 stays in the same place. To maintain the gap, the conveyor 508 can be extended or otherwise moved based on control instructions received by one or more computing devices (e.g., provided automatically by a robot and/or processed through one or more control devices associated with the conveyor 508). In some embodiments, the systems and methods shown and described above in FIG. 4 can be invoked to maintain the gap 512 at a substantially constant length (or within a desired range of distances) as the robot 504 repositions itself relative to the stack 524 as more boxes are removed (e.g., until all boxes in the stack 524 have been loaded onto the conveyor 508).

In some embodiments, one or more “safety zones” delineate regions in the environment of the robot 504 with differing safety characteristics. For example, a safety zone closest to the robot 504 can represent a first region (e.g., a location or set of locations in two or three dimensions that one or more entities could occupy) closest to the robot 504, while another safety zone can represent a second region (e.g., generally further away from the robot 504), and another safety zone can represent a third region (e.g., generally still further away from the robot 504). In some embodiments, location information associated with entities in the environment of the robot can be processed to indicate a presence (or absence) of an entity in one or more of the safety zones (e.g., in a safety zone closest to the robot 504). In such a situation, one set of operating parameters can be determined (e.g., a more conservative set) for when an entity is detected in the safety zone closest to the robot 504, while location information indicating a presence of an entity in a safety zone further from the robot 504 can result in a second set of operating parameters (e.g., a less conservative set) being generated and/or used by the robot 504. In some embodiments, the safety zones are administered by a safety system such as a zone controller (e.g., the zone controller 632 shown and described below in FIG. 6). In some embodiments, location information indicating that an entity occupies any part of a particular safety zone can be interpreted as the entity occupying the closest portion of the zone to the robot (e.g., for ease of computation, compatibility with existing zone controllers, and/or conservative calculations in view of the associated safety concerns). In some embodiments, some or all sensed location information can be provided to the zone controller so that the all distances are computed based on conservative approximations and/or to ensure interoperation with existing safety systems.

FIG. 6 is an illustration of a robot 604 and parcel handling equipment (here, a telescopic conveyor) 608 having an attached structure 648, according to an illustrative embodiment of the invention. The robot 604 is in a container 606 moving parcels (here boxes) from a stack of parcels 610 to the conveyor 608. As shown, the conveyor 608 is a telescopic conveyor, although other conveyors are also possible (e.g., a boom conveyor, an accordion conveyor, or a gravity conveyor). The conveyor 608 can include a motor drive 612 (e.g., a variable-frequency drive), which may have on-board motion controls (e.g., hold-to-run controls) with speed and/or acceleration limits. The conveyor 608 can also include a cabinet 616 in communication with the motor drive 612. The cabinet 616 can include one or more relays and/or motion controls (e.g., a forward control, a reverse control, an emergency stop control, and/or a reset control). In some embodiments, the cabinet 616 can include a programmable logic controller (PLC).

A mount 620 (e.g., a sensing arch) can be disposed relative to the conveyor 608 (e.g., fixed to the ground and/or surrounding the conveyor 608 on two sides). In some embodiments, the mount 620 includes a wireless access point 624, which can be used for communicating with the robot 604 (e.g., using a black-channel for safety-related data transmission and/or an ADS layer for other functions). In some embodiments, the mount 620 includes one or more sensors 626 (e.g., one or more cameras, LiDAR sensors, RADAR sensors, RF sensors, laser range finding sensors, Bluetooth sensors, RFID tags, and/or location tracking tags). In some embodiments, the one or more sensors 626 are configured to sense location information for the robot 604 and/or one or more entities in the environment of the robot 604. In some embodiments, a line of sight 628 between the mount 620 and the robot 604 enables the robot 604 to be located reliably in the environment. In some embodiments, the mount 620 holds one or more fiducials (e.g., identifying the mount 620 and/or one or more properties of the mount 620). In some embodiments, the mount 620 holds one or more lights (e.g., to indicate to a human when a safety zone is violated, when the robot 604 is slowing, and/or on which side of the conveyor 608 there has been a breach). In some embodiments, this information could help a user clear an object that has been sitting in the field (e.g., a misplaced pallet or piece of debris) and/or letting the user know that they are standing in a particular safety zone. In some embodiments, the mount 620 is physically separate from the robot 604.

In some embodiments, a zone controller 632 (e.g., a PLC) is in communication with the cabinet 616. The zone controller 632 can process location information such that the information is outputted as simply a presence or absence within a particular safety zone. In some embodiments, one or more connection(s) 636 to the cabinet 616 can include a modern field bus communication (e.g., Profinet, EtherCAT or logic I/O). In some embodiments, the connection(s) 636 to the cabinet 616 can enable direct control of the motor drive 612. In some embodiments, a switch 640 can be in communication with the zone controller 632 (e.g., to toggle between automatic and manual operation modes).

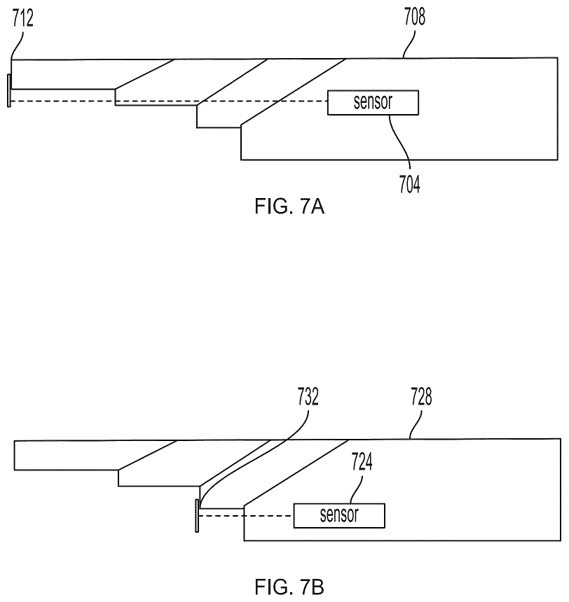

In some embodiments, an encoder 644 is attached to the conveyor 608 (or another location fixed relative to the conveyor 608). The encoder 644 can be configured to sense location information of the conveyor 608 (e.g., an absolute position of the conveyor and/or an amount of extension of the conveyor 608). In some embodiments, the location information corresponds to an end of the conveyor 608 (e.g., as shown and described below in FIG. 7A). In some embodiments, the location information corresponds to an end of a section of the conveyor 608 (e.g. as shown and described below in FIG. 7B), from which the end of the conveyor 608 can be inferred within a given uncertainty. In some embodiments, the encoder 644 can sense location information in a manner that is reliable for safety-related calculations to be performed (e.g., to a sufficient degree of accuracy) and/or is redundant with location information received from other sources.

In some embodiments, the structure 648 is attached to an end of the conveyor 608. The structure 648 can include one or more fiducials, which can be sensed by the robot 604 to determine information (e.g., a conveyor pose, a conveyor ID, and/or a zone ID) that can in certain situations be used to determine a location of the robot 604. In some embodiments, the robot 604 can sense a fiducial to verify a zone identification before transitioning to a manipulation task (at which point a LiDAR device can begin monitoring a region near a ramp). In some embodiments, having a line-of-sight to a fiducial can help ensure that the robot 604 is in front of the conveyor 608. In some embodiments, LiDAR fields can help ensure that the robot 604 has not moved to another bay). The structure 648 can also include a means of preventing the robot 604 from moving past a side of the conveyor 608. In some embodiments, this means comprises a purely physical constraint (e.g., a linear distance from either side of the structure 648 to the corresponding wall of the container is less than a width of the robot 604). In some embodiments, this means is implemented virtually (e.g., using one or more sensors on the structure 648 in communication with one or more computing devices controlling motion of the conveyor 608). In some embodiments, the structure 648 includes a RFID tag or other unique electronic identifier. In some embodiments, the conveyor 608 is configured to move from one bay to another within a warehouse environment, with the robot 604, autonomously and/or without human assistance.

In some embodiments, a computing device (not shown in FIG. 6, but an example is computing device 412 shown and described in FIG. 4) is configured to control motion and/or one or more operating parameters of the conveyor 608 (e.g., an amount of extension, a pitch, a lateral position, etc.). In some embodiments, the structure 648 can be retrofitted to work with existing conveyors, rather than requiring replacement of the conveyor, which can provide an important advantage as existing conveyors can be large and expensive. In some embodiments, the structure 648 includes the computing device and/or one or more sensing components for executing automatic motion control of the conveyor 608. In some embodiments, the structure 648 includes one or more sensors that sense information that can be used to direct motion and/or operation of the robot 604. In some embodiments, the structure 648 includes one or more visual fiducials that can assist the robot 604 in performing sensing (e.g., information reflecting a pose of the conveyor 608 and/or providing zone ID information). In some embodiments, visual fiducials and/or RF tags can be included in or on the structure 648 to provide information for sensing in machine readable format (e.g., as a barcode, QR code, etc.).

An environment (e.g., a warehouse) within which the mobile robot 604 is operating may include multiple zones, (e.g., work zones), each having its own associated safety system. At least some of the work zones may have equipment (e.g., conveyor 608) residing therein and with which mobile robot 604 may interact. In some embodiments, the mobile robot 604 may be configured to associate itself with one or more aspects of a particular work zone in the environment, e.g. by using multi-factor authentication to pair to the conveyor 608 in the work zone and/or to establish a trusted connection with the safety system of the work zone.

In some embodiments, the structure 648 includes a physical bumper, which can prevent the mobile robot 605 from passing to the side of the conveyor 608. In certain situations (e.g., in which the mobile robot 604 is further confined in a truck of finite width), the walls of the truck or other container within which the mobile robot is operating can limit the operating space of the mobile robot 604 to only a particular area in front of the conveyor 608 (e.g., because the mobile robot 604 does not have enough space to move past the front of the conveyor 608 on either side). In some embodiments, the encoder 644 can provide a measurement representing a minimum distance into the truck that the mobile robot 604 should be located. In some embodiments, the physical blocking function provided by the bumper can also be implemented electronically (e.g., through sensors that can trigger an automatic stop) rather than requiring a physical structure. Some existing conveyors include a bumper sensor. In some embodiments, the triggering area of this bumper sensor can be extended by adding hardware such as linkages and/or extensions.

FIGS. 7A-7B are illustrations of exemplary configurations of a sensor (e.g., the encoder 644 shown and described above in FIG. 6) configured to sense an extension length of a conveyor 708, according to illustrative embodiments of the invention. In FIG. 7A, the sensor 704 is attached to the conveyor 708 and measures a distance to an end 712 of the conveyor 708 (e.g., by emitting light to track one or more parameters of a reflected light signal such as time of flight or phase shift)). In some embodiments, the end 712 includes a target (e.g., an existing part of the conveyor 708 and/or an added component), which the sensor 704 can use to determine the distance and/or position of the end 712. In some embodiments, the target includes an encoded pattern (e.g., a barcode, QR code or magnetic pattern) that can be read by the sensor 704. In some embodiments, the sensor 704 can be pointed at a fixed location relative to the end 712. In some embodiments, the sensor 704 is part of a sensor assembly, which can be connected between a moving section and a fixed section of the conveyor 708 (e.g., to measure displacement of the sensor 704 directly). In some embodiments, the sensor assembly includes a string potentiometer, a linear potentiometer, and/or a linear variable differential transformer.

In FIG. 7B, the sensor 724 is attached to the conveyor 728 and measures a distance to an end 732 of a section of the conveyor (e.g., by methods similar to those described above in connection with FIG. 7A). In FIG. 7B, because the segments of the conveyor 728 extend outward in tandem (e.g., in a fixed ratio), measuring a distance to an end of one section can permit an inference about the total length of the conveyor 728, given sufficient information about the conveyor extension mechanics. In some embodiments, the technique for determining an extension length of the conveyor 728 in FIG. 7B may help to reduce errors due to lateral, vertical, and/or angular displacement of the end 732 (and/or a target included in the end 732), which may be due to vibrations and/or bending of the conveyor 728 while under load. In some embodiments, this approach can lead to a cleaner and/or steadier signal. In some embodiments, this approach can permit a smaller target to be used. In some embodiments, the opportunity for bodies in the environment to create physical interference with a distance measurement is less when a smaller distance is measured (e.g., when using a line of sight sensor). In some embodiments, intermediate sections of the conveyor 728 are less likely to be impacted (e.g., by a robot or other objects during loading and/or unloading operations).

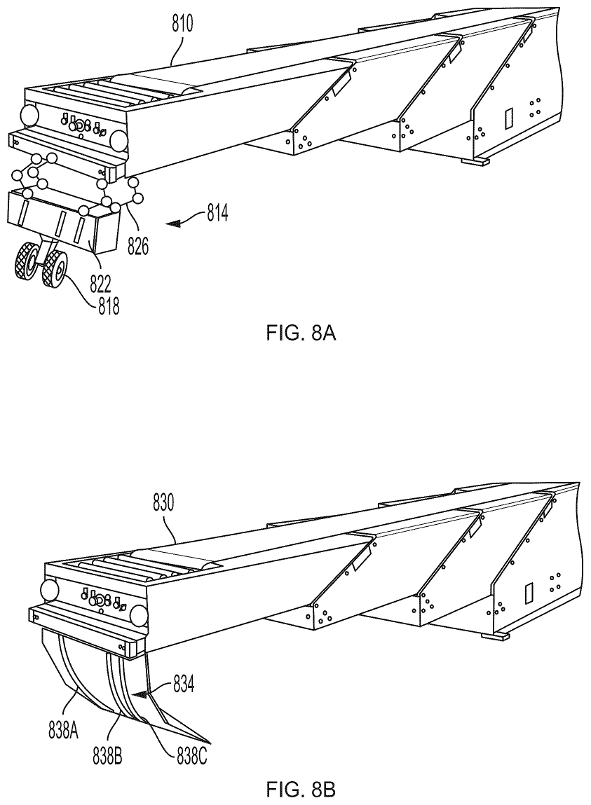

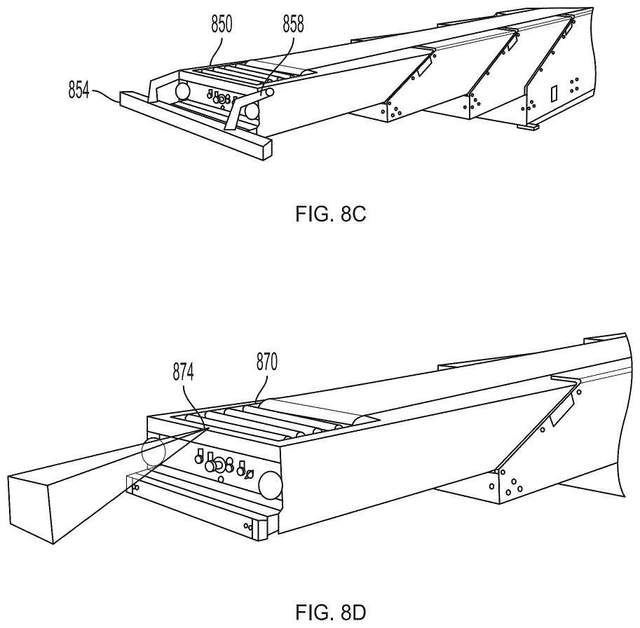

FIGS. 8A-8D are illustrations of exemplary elements of structures configured to couple to a conveyor, according to illustrative embodiments of the invention. FIG. 8A shows a telescopic conveyor 810 having a compliant member 814 to account for changes in ground clearance, which can helping to keep LiDAR signals received from the robot coplanar with the ground. The compliant member 814 can include a ground-contacting section 818 (e.g., wheels that contact and/or follow the ground under spring and/or gravity compression). The compliant member 814 can also include a tracking target 822 that the robot can sense (e.g., using a camera) and identify (e.g., a planar target with a retro-reflective pattern that can be differentiated from other objects that may be in the scene, such as dropped boxes). The compliant member 814 can also include a member 826 (e.g., a linkage and/or guided motion flexure) that accommodates vertical motion of the lower sections while constraining other aspects of motion (e.g., not allowing pitch, yaw, lateral, and/or forward/backward motion), which can help keep the tracking target 822 co-planar with the conveyor 810 and/or centered under the front of the conveyor 810.

FIG. 8B shows a telescopic conveyor 830 having a flexible target 834 (e.g., a fabric) having one or more reflectors 838A-C, which can reflect a signal output from a LiDAR sensor on a robot. On the robot, the LiDAR return sensor can output an intensity of the received signal. A high intensity can correspond to a signal that has hit a reflector, whereas a low intensity can correspond to a signal that has not hit a reflector. In some embodiments, the flexible target 834 can accomplish the functions of one or more (e.g., all three) of the elements 818, 822, 826 described above in connection with FIG. 8A. FIG. 8C shows a telescopic conveyor 850 having a push bar 854 attached to the conveyor 850 at one or more pivot points 858. The push bar 854 can be used as a safety measure, e.g., to stop and/or retract the conveyor 850 when depressed. The push bar 854 can also be extended wider than the push bar that may be found as part of the conveyor 850, e.g., to prevent the robot from passing the conveyor 850 (e.g., in a truck environment in which the robot is also constrained on either side of the conveyor 850). FIG. 8D shows a telescopic conveyor 870 having one or more sensors 874 (e.g., ultrasonic, RF, laser and/or camera sensors) to measure one or more parameters of the robot (e.g., position, presence, pose). These measured parameters can help to control the gap between the robot and the conveyor 870, prevent collisions by the robot, and/or be used in safety-related measurements (e.g., as part of a system to detect a full pose of the robot and/or its manipulator when combined with data from the robot's own sensors and/or other sensors in the environment).

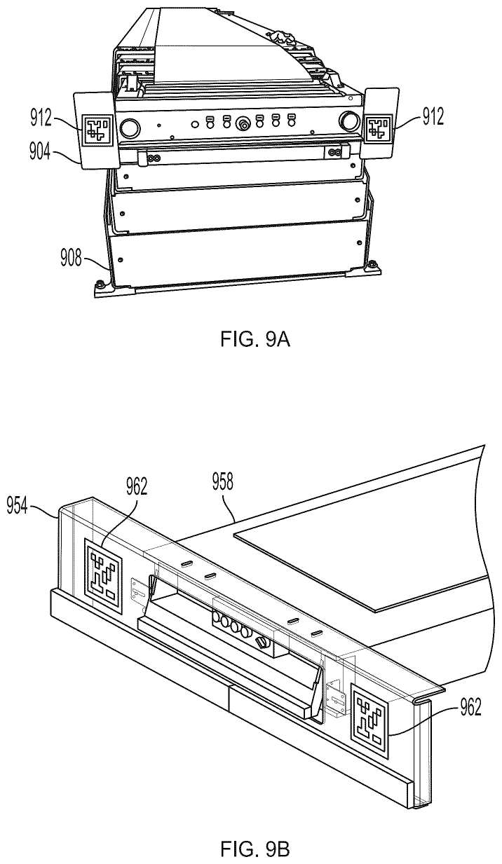

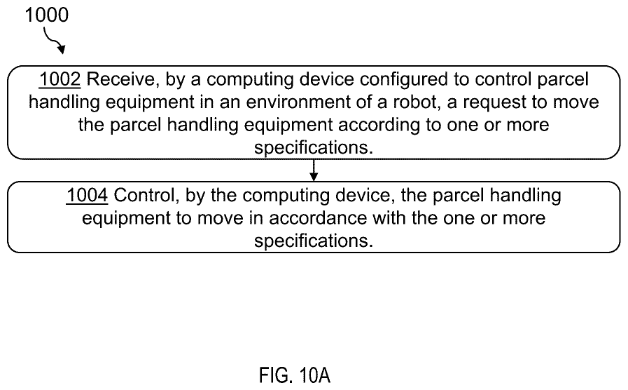

FIG. 9A is a front view photograph of a structure 904 attached to a conveyor 908, according to an illustrative embodiment of the invention. The structure 904 includes one or more fiducials 912, which can be used to identify the conveyor 908 and/or track a position of the conveyor 908. The structure 904 can also include wings, which can keep the robot (not shown) from passing the conveyor 908 on the side while in a truck of a sufficiently small width (e.g., where a distance from one side of the conveyor 908 to the truck wall is less than a width of the robot). In some embodiments, the conveyor 908 includes a RFID tag to assist in identifying and/or tracking the conveyor 908.

FIG. 9B is a perspective view illustration of a structure 954 attached to a conveyor 958, according to an illustrative embodiment of the invention. The structure 954 can be constructed of a unibody sheet metal and/or another suitable material. The structure 954 can also include one or more fiducials 962. In some embodiments, a plurality of redundant fiducials 962 is included to increase the chance that at least one fiducial 962 is visible for any location of the robot in the workspace (e.g., to prevent an occlusion in the scene from halting operations).

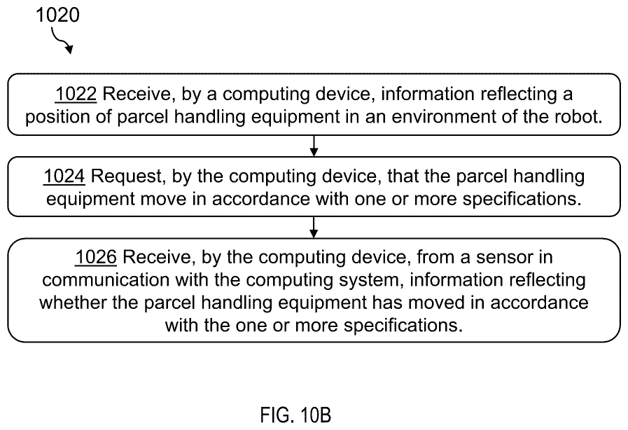

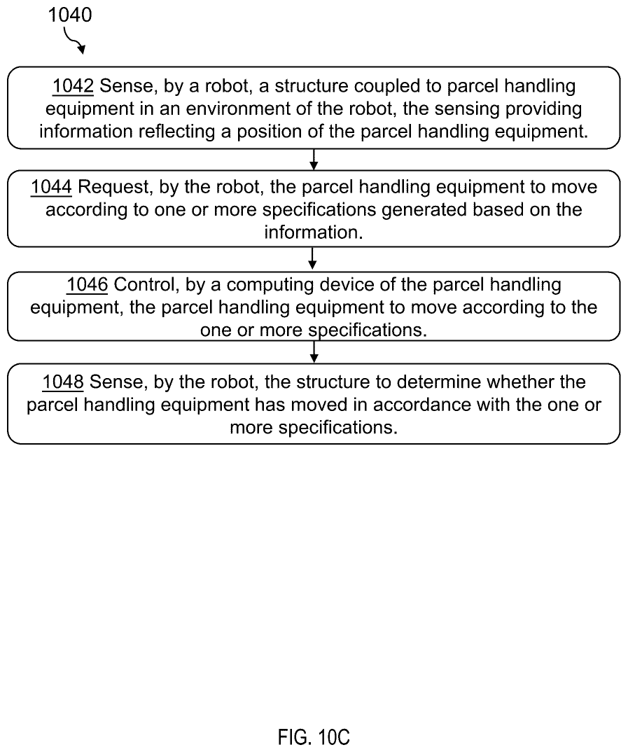

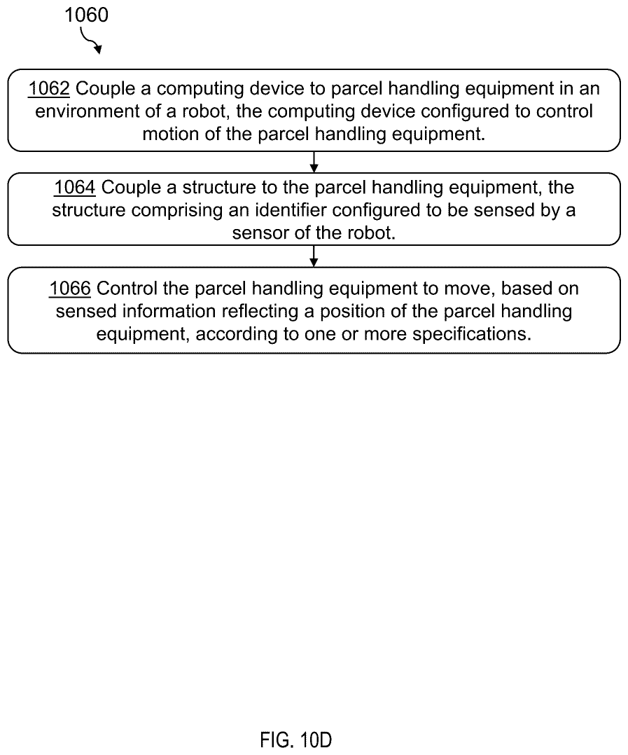

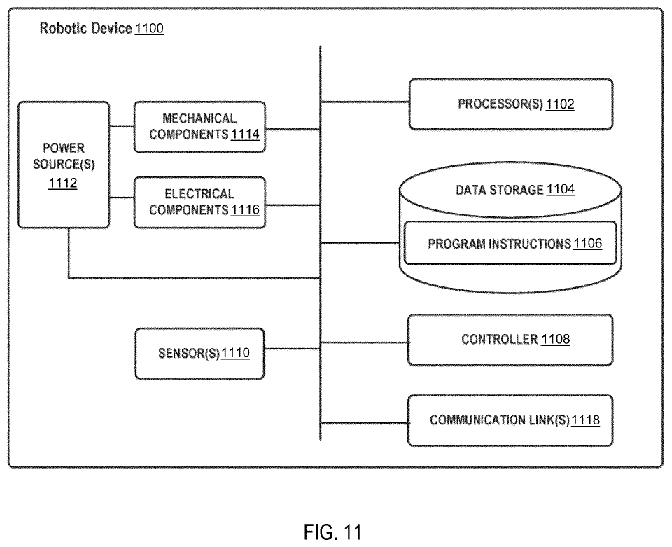

FIGS. 10A-10D are flow diagrams of methods 1000, 1020, 1040, 1060 according to illustrative embodiments of the invention. In FIG. 10A, at step 1002, a computing device configured to control parcel handling equipment in an environment of a robot receives a request to move the parcel handling equipment according to one or more specifications (e.g., by a robot autonomously and/or without input from a human). At step 1004, the computing device controls the parcel handling equipment to move in accordance with the one or more specifications. The request to move the parcel handling equipment is based on information about a position of the parcel handling equipment. In FIG. 10B, at step 1022, a computing device receives information reflecting a position of a parcel handling equipment in an environment of the robot. At step 1024, the computing device requests that the parcel handling equipment move in accordance with one or more specifications. At step 1026, the computing device receives, from a sensor in communication with the computing system, information reflecting whether the parcel handling equipment has moved in accordance with the one or more specifications.

In FIG. 10C, at step 1042, a robot senses a structure coupled to a parcel handling equipment in an environment of the robot. The sensing provides information reflecting a position of the parcel handling equipment. At step 1044, the robot requests the parcel handling equipment to move according to one or more specifications generated based on the information. At step 1046, a computing device of the parcel handling equipment controls the parcel handling equipment to move according to the one or more specifications. At step 1048, the robot senses the structure to determine whether the parcel handling equipment has moved in accordance with the one or more specifications. In FIG. 10D, at step 1062, a computing device is coupled to a parcel handling equipment in an environment of a robot. The computing device is configured to control motion of the parcel handling equipment. At step 1064, a structure is coupled to the parcel handling equipment. The structure comprises an identifier configured to be sensed by a sensor of the robot. At step 1066, the parcel handling equipment is controlled to move, based on sensed information reflecting a position of the parcel handling equipment, according to one or more specifications.

FIG. 11 illustrates an example configuration of a robotic device 1100, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

Referring now to the figures, FIG. 11 illustrates an example configuration of a robotic device (or “robot”) 1100, according to an illustrative embodiment of the invention. The robotic device 1100 represents an example robotic device configured to perform the operations described herein. Additionally, the robotic device 1100 may be configured to operate autonomously, semi-autonomously, and/or using directions provided by user(s), and may exist in various forms, such as a humanoid robot, biped, quadruped, or other mobile robot, among other examples. Furthermore, the robotic device 1100 may also be referred to as a robotic system, mobile robot, or robot, among other designations.

As shown in FIG. 11, the robotic device 1100 includes processor(s) 1102, data storage 1104, program instructions 1106, controller 1108, sensor(s) 1110, power source(s) 1112, mechanical components 1114, and electrical components 1116. The robotic device 1100 is shown for illustration purposes and may include more or fewer components without departing from the scope of the disclosure herein. The various components of robotic device 1100 may be connected in any manner, including via electronic communication means, e.g., wired or wireless connections. Further, in some examples, components of the robotic device 1100 may be positioned on multiple distinct physical entities rather on a single physical entity. Other example illustrations of robotic device 1100 may exist as well.

Processor(s) 1102 may operate as one or more general-purpose processor or special purpose processors (e.g., digital signal processors, application specific integrated circuits, etc.). The processor(s) 1102 can be configured to execute computer-readable program instructions 1106 that are stored in the data storage 1104 and are executable to provide the operations of the robotic device 1100 described herein. For instance, the program instructions 1106 may be executable to provide operations of controller 1108, where the controller 1108 may be configured to cause activation and/or deactivation of the mechanical components 1114 and the electrical components 1116. The processor(s) 1102 may operate and enable the robotic device 1100 to perform various functions, including the functions described herein.

The data storage 1104 may exist as various types of storage media, such as a memory. For example, the data storage 1104 may include or take the form of one or more computer-readable storage media that can be read or accessed by processor(s) 1102. The one or more computer-readable storage media can include volatile and/or non-volatile storage components, such as optical, magnetic, organic or other memory or disc storage, which can be integrated in whole or in part with processor(s) 1102. In some implementations, the data storage 1104 can be implemented using a single physical device (e.g., one optical, magnetic, organic or other memory or disc storage unit), while in other implementations, the data storage 1104 can be implemented using two or more physical devices, which may communicate electronically (e.g., via wired or wireless communication). Further, in addition to the computer-readable program instructions 1106, the data storage 1104 may include additional data such as diagnostic data, among other possibilities.

The robotic device 1100 may include at least one controller 1108, which may interface with the robotic device 1100. The controller 1108 may serve as a link between portions of the robotic device 1100, such as a link between mechanical components 1114 and/or electrical components 1116. In some instances, the controller 1108 may serve as an interface between the robotic device 1100 and another computing device. Furthermore, the controller 1108 may serve as an interface between the robotic system 1100 and a user(s). The controller 1108 may include various components for communicating with the robotic device 1100, including one or more joysticks or buttons, among other features. The controller 1108 may perform other operations for the robotic device 1100 as well. Other examples of controllers may exist as well.

Additionally, the robotic device 1100 includes one or more sensor(s) 1110 such as force sensors, proximity sensors, motion sensors, load sensors, position sensors, touch sensors, depth sensors, ultrasonic range sensors, and/or infrared sensors, among other possibilities. The sensor(s) 1110 may provide sensor data to the processor(s) 1102 to allow for appropriate interaction of the robotic system 1100 with the environment as well as monitoring of operation of the systems of the robotic device 1100. The sensor data may be used in evaluation of various factors for activation and deactivation of mechanical components 1114 and electrical components 1116 by controller 1108 and/or a computing system of the robotic device 1100.

The sensor(s) 1110 may provide information indicative of the environment of the robotic device for the controller 1108 and/or computing system to use to determine operations for the robotic device 1100. For example, the sensor(s) 1110 may capture data corresponding to the terrain of the environment or location of nearby objects, which may assist with environment recognition and navigation, etc. In an example configuration, the robotic device 1100 may include a sensor system that may include a camera, RADAR, LIDAR, time-of-flight camera, global positioning system (GPS) transceiver, and/or other sensors for capturing information of the environment of the robotic device 1100. The sensor(s) 1110 may monitor the environment in real-time and detect obstacles, elements of the terrain, weather conditions, temperature, and/or other parameters of the environment for the robotic device 1100.

Further, the robotic device 1100 may include other sensor(s) 1110 configured to receive information indicative of the state of the robotic device 1100, including sensor(s) 1110 that may monitor the state of the various components of the robotic device 1100. The sensor(s) 1110 may measure activity of systems of the robotic device 1100 and receive information based on the operation of the various features of the robotic device 1100, such the operation of extendable legs, arms, or other mechanical and/or electrical features of the robotic device 1100. The sensor data provided by the sensors may enable the computing system of the robotic device 1100 to determine errors in operation as well as monitor overall functioning of components of the robotic device 1100.

For example, the computing system may use sensor data to determine the stability of the robotic device 1100 during operations as well as measurements related to power levels, communication activities, components that require repair, among other information. As an example configuration, the robotic device 1100 may include gyroscope(s), accelerometer(s), and/or other possible sensors to provide sensor data relating to the state of operation of the robotic device. Further, sensor(s) 1110 may also monitor the current state of a function that the robotic system 1100 may currently be operating. Additionally, the sensor(s) 1110 may measure a distance between a given robotic limb of a robotic device and a center of mass of the robotic device. Other example uses for the sensor(s) 1110 may exist as well.

Additionally, the robotic device 1100 may also include one or more power source(s) 1112 configured to supply power to various components of the robotic device 1100. Among possible power systems, the robotic device 1100 may include a hydraulic system, electrical system, batteries, and/or other types of power systems. As an example illustration, the robotic device 1100 may include one or more batteries configured to provide power to components via a wired and/or wireless connection. Within examples, components of the mechanical components 1114 and electrical components 1116 may each connect to a different power source or may be powered by the same power source. Components of the robotic system 1100 may connect to multiple power sources as well.

Within example configurations, any type of power source may be used to power the robotic device 1100, such as a gasoline and/or electric engine. Further, the power source(s) 1112 may charge using various types of charging, such as wired connections to an outside power source, wireless charging, combustion, or other examples. Other configurations may also be possible. Additionally, the robotic device 1100 may include a hydraulic system configured to provide power to the mechanical components 1114 using fluid power. Components of the robotic device 1100 may operate based on hydraulic fluid being transmitted throughout the hydraulic system to various hydraulic motors and hydraulic cylinders, for example. The hydraulic system of the robotic device 1100 may transfer a large amount of power through small tubes, flexible hoses, or other links between components of the robotic device 1100. Other power sources may be included within the robotic device 1100.

Mechanical components 1114 can represent hardware of the robotic system 1100 that may enable the robotic device 1100 to operate and perform physical functions. As a few examples, the robotic device 1100 may include actuator(s), extendable leg(s), arm(s), wheel(s), one or multiple structured bodies for housing the computing system or other components, and/or other mechanical components. The mechanical components 1114 may depend on the design of the robotic device 1100 and may also be based on the functions and/or tasks the robotic device 1100 may be configured to perform. As such, depending on the operation and functions of the robotic device 1100, different mechanical components 1114 may be available for the robotic device 1100 to utilize. In some examples, the robotic device 1100 may be configured to add and/or remove mechanical components 1114, which may involve assistance from a user and/or other robotic device.

The electrical components 1116 may include various components capable of processing, transferring, providing electrical charge or electric signals, for example. Among possible examples, the electrical components 1116 may include electrical wires, circuitry, and/or wireless communication transmitters and receivers to enable operations of the robotic device 1100. The electrical components 1116 may interwork with the mechanical components 1114 to enable the robotic device 1100 to perform various operations. The electrical components 1116 may be configured to provide power from the power source(s) 1112 to the various mechanical components 1114, for example. Further, the robotic device 1100 may include electric motors. Other examples of electrical components 1116 may exist as well.

In some implementations, the robotic device 1100 may also include communication link(s) 1118 configured to send and/or receive information. The communication link(s) 1118 may transmit data indicating the state of the various components of the robotic device 1100. For example, information read in by sensor(s) 1110 may be transmitted via the communication link(s) 1118 to a separate device. Other diagnostic information indicating the integrity or health of the power source(s) 1112, mechanical components 1114, electrical components 1118, processor(s) 1102, data storage 1104, and/or controller 1108 may be transmitted via the communication link(s) 1118 to an external communication device.

In some implementations, the robotic device 1100 may receive information at the communication link(s) 1118 that is processed by the processor(s) 1102. The received information may indicate data that is accessible by the processor(s) 1102 during execution of the program instructions 1106, for example. Further, the received information may change aspects of the controller 1108 that may affect the behavior of the mechanical components 1114 or the electrical components 1116. In some cases, the received information indicates a query requesting a particular piece of information (e.g., the operational state of one or more of the components of the robotic device 1100), and the processor(s) 1102 may subsequently transmit that particular piece of information back out the communication link(s) 1118.

In some cases, the communication link(s) 1118 include a wired connection. The robotic device 1100 may include one or more ports to interface the communication link(s) 1118 to an external device. The communication link(s) 1118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

What is claimed is:

1. A kit comprising:
a computing system configured to control motion of parcel handling equipment in an environment of a mobile robot; and
a structure configured to couple to the parcel handling equipment, the structure comprising an identifier configured to be sensed by a sensor of the mobile robot.

2. The kit of claim 1, wherein the parcel handling equipment comprises a conveyor.

3-10. (canceled)

11. The kit of claim 1, wherein the structure comprises a compliant member configured to adjust to variations in a clearance of the parcel handling equipment relative to a ground plane.

12. The kit of claim 1, wherein the computing system is configured to issue control instructions to constrain a position of the mobile robot relative to the parcel handling equipment.

13-17. (canceled)

18. The kit of claim 1, wherein the computing system is configured to communicate with a motion control system of the parcel handling equipment.

19. The kit of claim 1, wherein the computing system is configured to control motion of the parcel handling equipment by controlling one or more motors of the parcel handling equipment.

20. The kit of claim 1, wherein the computing system is configured to control motion of the parcel handling equipment based at least in part on position data sensed by the mobile robot.

21-25. (canceled)

26. The kit of claim 1, further comprising a switch in communication with the computing system, the switch configured to toggle the computing system between an automated mode and a manual mode.

27-32. (canceled)

33. The kit of claim 1, wherein the computing system is configured to maintain a gap between the parcel handling equipment and the mobile robot.

34-56. (canceled)

57. A method comprising:
receiving, by a computing system of a mobile robot, information indicating a position of parcel handling equipment in an environment of the mobile robot;
requesting, by the computing system, that the parcel handling equipment move in accordance with one or more specifications; and
receiving, by the computing system, from a sensor in communication with the computing system, information indicating whether the parcel handling equipment has moved in accordance with the one or more specifications.

58-60. (canceled)

61. The method of claim 57, wherein the information indicating the position of the parcel handling equipment in the environment of the mobile robot is provided on a structure configured to couple to the parcel handling equipment, the structure comprising an identifier configured to be sensed by a sensor of the mobile robot.

62-69. (canceled)

70. The method of claim 57, wherein the information indicating a position of the parcel handling equipment includes an indication of a presence or absence of an entity in a specified safety zone in the environment of the mobile robot.

71-112. (canceled)

113. A computing system of a mobile robot comprising:
data processing hardware; and
memory hardware in communication with the data processing hardware, the memory hardware storing instructions that when executed on the data processing hardware cause the data processing hardware to perform operations comprising:
receiving information indicating a position of parcel handling equipment in an environment of the mobile robot;
requesting that the parcel handling equipment move in accordance with one or more specifications; and
receiving from a sensor in communication with the computing system, information indicating whether the parcel handling equipment has moved in accordance with the one or more specifications.

114-117. (canceled)

118. The computing system of claim 113, wherein the information indicating the position of the parcel handling equipment comprises a distance from the parcel handling equipment to the mobile robot.

119. (canceled)

120. The computing system of claim 113, wherein the one or more specifications include at least one of a target distance to the mobile robot, a minimum permitted distance to the mobile robot, or a maximum permitted distance to the mobile robot.

121. The computing system of claim 113, wherein the one or more specifications include at least one of a target ground speed of the parcel handling equipment, a minimum ground speed of the parcel handling equipment, or a maximum ground speed of the parcel handling equipment.

122. The computing system of claim 113, wherein the one or more specifications include at least one of a target move time of the parcel handling equipment, a minimum move time of the parcel handling equipment, or a maximum move time of the parcel handling equipment.

123. The computing system of claim 113, wherein the one or more specifications include at least one of a target extension length of the parcel handling equipment, a minimum extension length of the parcel handling equipment, or a maximum extension length of the parcel handling equipment.

124. The computing system of claim 113, wherein the one or more specifications include at least one of a target belt speed of the parcel handling equipment, a minimum belt speed of the parcel handling equipment, or a maximum belt speed of the parcel handling equipment.

125. The computing system of claim 113, wherein the one or more specifications include a target pitch axis of the parcel handling equipment.

126-147. (canceled)
